(19) United States
(12) Patent Application Publication
(10) Pub. No.: US 2026/0082291 A1
(43) Pub. Date: Mar. 19, 2026

(54) CELLULAR USER IMMUNITY

(71) Applicant: Ubiqam Ltd., Petach-Tikva (IL)

(72) Inventors: Baruch CYZS, Kiryat-Motzkin (IL); Oren AMIDAN, Kochav Yair (IL); Amir MEIR, Tel-Aviv (IL); Daniel MANOR, Ramat Gan (IL)

(73) Assignee: Ubiqam Ltd., Petach-Tikva (IL)

(21) Appl. No.: 19/102,401

(22) PCT Filed: Aug. 9, 2023
(86) PCT No.: PCT/IL2023/050826

§ 371 Date: Feb. 9, 2025

(30) Foreign Application Priority Data
Aug. 9, 2022 (IL) 295522

(51) Int. Cl. H04W 36/08; H04W 36/00

(52) U.S. Cl. CPC H04W 36/08; H04W 36/00837

(57) ABSTRACT

There is provided an apparatus for mitigating foreign interference of a mobile device, comprising: a processor executing a code for: identifying a serving base station that is serving the mobile device, identifying at least one handover base station that the mobile device is likely to handover to, and computing a set of weights for generating by a plurality of antennas associated with the mobile device, a composite beam pattern that includes beams steered towards the serving base station and for the at least one handover base station, and that forms null towards at least one interference source.

### RELATED APPLICATION

This application claims the benefit of priority of Israeli Patent Application No. 295522 filed on Aug. 9, 2022, the contents of which are incorporated herein by reference in their entirety.

### BACKGROUND

The present invention, in some embodiments thereof, relates to cellular communication networks and, more specifically, but not exclusively, to systems and methods for protecting user equipment from interference sources.

Interference by interference sources transmitting on a cellular network may impact performance of a mobile device connected to the network, for example, reducing quality of transmission (e.g., reduced download speeds) and/or problems in hand-offs (e.g., dropped connections during the hand-off).

### SUMMARY

According to a first aspect, an apparatus for mitigating foreign interference of a mobile device, comprises: a processor executing a code for: identifying a serving base station that is serving the mobile device, identifying at least one handover base station that the mobile device is likely to handover to, and computing a set of weights for generating by a plurality of antennas associated with the mobile device, a composite beam pattern that includes beams steered towards the serving base station and for the at least one handover base station, and that forms null towards at least one interference source.

According to a second aspect, a method of mitigating foreign interference of a mobile device, comprises: identifying a serving base station that is serving the mobile device, identifying at least one handover base station that the mobile device is likely to handover to, and computing a set of weights for generating by a plurality of antennas associated with the mobile device, a composite beam pattern that includes beams steered towards the serving base station and for the at least one handover base station, and that forms null towards at least one interference source.

According to a third aspect, a non-transitory medium storing program instructions for mitigating foreign interference of a mobile device, which when executed by at least one processor, cause the at least one processor to: identify a serving base station that is serving the mobile device, identify at least one handover base station that the mobile device is likely to handover to, and compute a set of weights for generating by a plurality of antennas associated with the mobile device, a composite beam pattern that includes beams steered towards the serving base station and for the at least one handover base station, and that forms null towards at least one interference source.

In a further implementation form of the first, second, and third aspects, the set of weights are computed for reducing or eliminating interference by the interference sources on a download link (DL) of the mobile device from the serving base station.

In a further implementation form of the first, second, and third aspects, the set of weights are computed according to signal trace of the interference sources and of the serving base station and the at least one handover base station, wherein a time interval of the signal trace is significantly longer than reception slot duration of the mobile device.

In a further implementation form of the first, second, and third aspects, the processor further executes code for: for a respective handover base station of the handover base stations, computing a sub-set of weights for steering a beam generated by the plurality of antennas to the respective handover base station and forming a null towards at least one of the handover base stations excluding the respective handover station and towards at least one of the interference sources, and computing the set of weights as a combination of a plurality of the sub-set of weights.

In a further implementation form of the first, second, and third aspects, the interference source comprises at least one other interfering base station in communication with a wireless network that includes the serving base station and the at least one handover base station, the at least one other interfering base station generating frequency reuse noise by reusing a frequency band used by at least one of the serving base station and the at least one handover base station, wherein the set of weights are selected for nulling the interference base station's frequency reuse noise.

In a further implementation form of the first, second, and third aspects, the processor is configured for performing in a plurality of iterations: identifying a new set of the at least one handover base station from a plurality of candidate base stations, and computing a new set of the set of weights for steering the beam to another handover base station.

In a further implementation form of the first, second, and third aspects, a time interval for computing the new set of the set of weights for forming the null is selected to be shorter than a time interval in which the null significantly changes location in response to changing location of the mobile device.

In a further implementation form of the first, second, and third aspects, a time interval for identifying the new set of the plurality of handover base stations is significantly longer than the time interval for computing the new set of the set of weights.

In a further implementation form of the first, second, and third aspects, the mobile device is installed within a drone, and the processor executes the plurality of iterations as the drone changes locations.

In a further implementation form of the first, second, and third aspects, the processor executes the plurality of iterations in response to changing locations of the mobile device.

In a further implementation form of the first, second, and third aspects, the at least one handover base station and the serving base station are identified by: searching for unique signals generated by each of a plurality of base stations, sorting receptive power levels of the unique signals in descending order, and selecting a predefined number of highest power unique signals, wherein the serving base station is selected according to a highest power unique signals and the at least one handover base station is selected according to descending power of the unique signals.

In a further implementation form of the first, second, and third aspects, the processor is further configured for: determining the presence of an interference signal originating from at least one foreign transmitting source in received signals received by the plurality of antennas, determining the presence of the unique signals in the received signals, calculating cancellation weight for a suitable combination of the received signals, such that the cancellation weights calculated based on existence of the interference signal and unique signals reject the interference signal, and leave the unique signals substantially unaffected.

In a further implementation form of the first, second, and third aspects, the apparatus is implemented as an add-on to the mobile device, and further comprising a first interface for electrically coupling to the plurality of antennas, and a second interface for electrically coupling to the mobile device.

In a further implementation form of the first, second, and third aspects, a number of the plurality of antennas associated with the mobile device is below a sum of a number of interference sources and a number of the serving base station and the at least one handover station, while maintaining sufficient degrees of freedom for cancellation of the interference sources.

In a further implementation form of the first, second, and third aspects, in response to the plurality of antennas associated with the mobile device implemented as an antenna array, a common beam is steered towards two or more of the serving base station and/or handovers base stations.

In a further implementation form of the first, second, and third aspects, in response to the plurality of antennas associated with the mobile device implemented as an antenna array, a common null is formed towards two or more of the interference sources.

In a further implementation form of the first, second, and third aspects, the plurality of antennas associated with the mobile device are implemented as at least one of: a vertical array, a horizontal antenna array, and a polar array.

In a further implementation form of the first, second, and third aspects, in response to the at least one handover base station having known bounded angle of arrival spread, the plurality of antennas associated with the mobile device are implemented as directional antennas configured to cover the known bounded angle of arrival spread.

In a further implementation form of the first, second, and third aspects, in response to inability to form nulls towards the interference sources, the set of weights are selected for generating a single beam with narrow width directed towards the serving base station.

In a further implementation form of the first, second, and third aspects, in response to reception power from remote interference sources being significantly lower than reception power from closer interference sources, computing the set of weights for forming nulls towards the closer interference sources and ignoring the remote interference sources.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of a system that includes an interference cancellation apparatus for mitigating foreign interference for a user equipment, in accordance with some embodiments of the present invention; and

FIG. 2 is a flowchart of a method for mitigating foreign interference for a user equipment, in accordance with some embodiments of the present invention.

### DETAILED DESCRIPTION

The present invention, in some embodiments thereof, relates to cellular communication networks and, more specifically, but not exclusively, to systems and methods for protecting user equipment from interference sources.

As used herein, the terms component, module, apparatus, and device, for example, for mitigating foreign interference, are interchangeable.

As used herein, the term mobile device and user equipment (UE) are interchangeable. The mobile device is used as an exemplary implementation of the user equipment that changes location, optionally rapidly and/or continuously, for example, a drone. The term mobile device may refer to a drone.

As used herein, the terms interference sources (or interference) and jammers (or jamming) are used interchangeably.

As used herein, the term antenna may refer to an antenna element. For example, multiple antennas may refer to multiple antenna elements, which may be used to steer a beam peak and/or null. The term antenna and antenna elements may be used interchangeably.

An aspect of some embodiments of the present invention relates to an apparatus, a module, a component, a device, a system, a method, and/or code (stored on a data storage device and executable by one or more processors) for mitigating foreign interference of a user equipment, optionally a mobile device, that may change location. A processor identifies a serving base station that is serving the mobile device. One or more handover base stations that the mobile device is likely to handover to are identified. A set of weights is computed for generating a composite beam pattern that includes beams steered towards the serving base station and for one or more of the handover base station(s), and that forms null towards one or more interference sources. The composite beam pattern is generated by antennas associated with the mobile device. The set of weights may be are computed for reducing or eliminating interference by the interference sources on a download link (DL) of the mobile device from the serving base station.

At least some embodiments of the components, systems, methods, computing devices, and/or code instructions (stored on a data storage device and executable by one or more processors) described herein address the technical problem of reducing or eliminating impact of interference by an interference source on a mobile device.

At least some embodiments of the components, systems, methods, computing devices, and/or code instructions described herein improve the technology of wireless (e.g., cellular) communication networks, by reducing or eliminating impact of interference by an interference source on a mobile device.

At least some embodiments of the components, systems, methods, computing devices, and/or code instructions described herein improve upon prior approaches for reducing or eliminating impact of interference by an interference source, in particular on a mobile device.

Mobile devices (e.g., user equipment) communicating with base stations of a wireless network are susceptible to interference from different sources.

There are several scenarios that may result in unwanted interference at the received spectrum of a mobile device. One example is intentional interference, also known as jamming. Such interference is created intentionally in order to harm a wireless network and prevent communication. Jammers may be employed in defense scenarios and the proposed solution may be used to protect a communication system against hostile jammers. The interference may originate from a foreign interferer, a transmitter that is not part of the immediate network. The interference may originate, for example, from a remotely located transmitter, carried by atmospheric propagation such as a tropospheric duct, or from a near-by located transmitter that transmits on frequencies that are overlapping and/or adjacent to the spectrum used by the interfered mobile device. Remote interferers may broadcast transmissions such as analog or digital TV from other countries.

In civilian communication the usage of jammers is rare and in many cases the interference is caused unintentionally. For example, the interference may be a result of transmission on the same frequency band by different base stations. Such interference may be experienced, for example, by a drone with cellular communication hardware on board, that is within communication of the one or more base stations that use the same frequency band.

At least some embodiments described herein address the aforementioned technical problem(s) and/or improve upon the aforementioned technology and/or improve upon the aforementioned prior approaches, by preventing or reducing interference to the mobile device (i.e., UE), for example, in comparison to other approaches that are directed towards preventing or reducing interference to the base station.

At least some embodiments described herein address the aforementioned technical problem(s) and/or improve upon the aforementioned technology and/or improve upon the aforementioned prior approaches, by computing weights to maximize signal to interference and noise ratio (SINR) to the mobile device being protected. The SINR may be maximized by maximizing the signal component of the SINR, by computing weights for steering beam(s) towards the serving base station and/or handover base stations, and forming null(s) towards the interference sources (e.g., jammers). The maximize SINR approach is different than other approaches that compute weights for minimizing noise to the protected device, for example, cancelling and/or reducing interference on the received signals. It is noted that the minimizing noise approach may be used in some embodiments described herein in combination with the approach to maximize SINR, for example, to locate the handover base stations.

Computing weights to maximize signal to interference and noise ratio (SINR) to the mobile device being protected, using at least some embodiments described herein, addresses technical problems that would otherwise be encountered by implementing other approaches based on minimizing noise and/or improves upon other approaches based on minimizing noise. For example, minimizing noise may steering null toward the existing jammers without any significant impact of the desired signal to this weights. In contrast, at least some approaches described herein steer beams towards the base stations for increasing the desired signals. In another example, using approaches that minimize noise, the number of receiving antennas should be at least the number of jammers plus one in order provide sufficient degrees of freedom for minimizing noise. In contrast, at least some approaches described herein that maximize SINR enable using fewer antennas that would be required for approaches that minimize noise.

It is noted that embodiments for protecting the UEs (e.g., mobile devices) from interference are different than other approaches for protecting the base station from interference. For example, embodiments for protecting the UEs are designed to protect the upload link (UL, i.e., data transmitted from the UE to the base station) from interference, whereas other approaches for protecting the base station protect the download link (DL, i.e., transmitted from the base station to the UE). In another example, protecting the UE from interference may involve a simpler design, since communication between jammers and the base station are usually far more stationary and less dynamic than communication between the UE and the base station, since the UEs which may be mobile devices, tend to change location, optionally repeatedly. In another example, in embodiments for protecting the UEs, weights computed as described herein for protecting the UE may be calculated from signal trace that is significantly longer than UE reception slot duration. Computing weights from the signal trace may be more efficient in terms of cancelation of interference than weights calculated per short UE slot reception as may be done in approaches that protect the UL of the base station. UE reception slot duration may be used for computing weights for protecting the UL of base stations may be less efficient (than computing weights from signal trace for protecting the DL for the UE) since UEs tend to move often and/or UEs tend to appear and disappear quickly and often.

At least some embodiments of the components, systems, methods, computing devices, and/or code instructions described herein address the technical problem of reducing a number of antennas used by a UE for computing weights for cancelling interference signals transmitted by external interferers (e.g., base stations) and received by the UE. At least some embodiments of the components, systems, methods, computing devices, and/or code instructions described herein improve the technical field of signal cancellation, by reducing a number of antennas used by a UE for computing weights for cancelling interference signals transmitted by external interferers (e.g., base stations) and received by the UE.

Using standard approaches, in order to compute cancellation weights for cancelling interference by interference signals transmitted by external interferers (e.g., base stations) and received by the UE, the number of receiving antennas should be greater than the number of external interferes (e.g., jammers) plus the number of received base stations (sometimes referred to as a degrees of freedom rule). The number of antennas that to be installed for the UE may be large, for example, when the number of predicted external interferes is known and/or large. Increasing the number of antennas is problematic for mobile UE, for example, a drone, where weight is an issue.

At least some embodiments of the components, systems, methods, computing devices, and/or code instructions described herein address the aforementioned technical problem, and/or improve the aforementioned technical field, by reducing the number of antennas installed in association with the UE (e.g., antennas installed on the drone).

At least some embodiments of the components, systems, methods, computing devices, and/or code instructions described herein address the technical problem of cancelling noise for a mobile UE that moves, for example, continuously and/or repeatedly. At least some embodiments of the components, systems, methods, computing devices, and/or code instructions described herein improve the technology of cancelling interference for a mobile UE that moves, for example, continuously and/or repeatedly. In contrast to other approaches for cancelling interference for a base station, which is stationary, cancelling interference for a UE that moves is different. Null steering for the UE that moves is technically challenging, since the null tends to be narrow (and may be dependent on the antenna element spacing). Beam speak steering for the UE that moves may be less technically challenging. The beam peak may be significantly wider than the null and/or depending on the antenna array size, which may make beam peak steering less sensitive to the movement of the UE in comparison to null steering.

At least some embodiments of the components, systems, methods, computing devices, and/or code instructions described herein address the aforementioned technical problem, and/or improve the aforementioned technical field, by using beam formation approaches for cancellation of interference for the UE that moves. Beam formation approaches may provide fair reception quality and/or sufficiently good SNIR, even with very agile UE and/or with strong urban scattering. The lower impact of the dynamics may help the UE maintain its normal handover process. According to some embodiments, there will be never UE blindness to the serving and all other neighboring base stations.

At least some embodiments described herein may employs two periodic processes, weight update (i.e., computing cancellation weights) and cell search (i.e., searching for base stations which are potentiation handoff targets for the UE) for steering of the beam and/or the null. When the weight calculation process is for both beam formation and null steering, the period of weight calculation may be sufficiently short in order to accommodate the null steering dynamics (since null is narrow and may require short internals for steering the null such as when the UE moves, as discussed above). However, the beam former portion may be updated during significantly longer period since it exhibits far lower dynamics. As such, the computationally intensive processes of finding base stations (e.g., timing and generating their current expected CRS, as described herein), may be done periodically with significantly lower rate. The beam former portion may be updated every predetermined number of periods of the null steering portion. The cell search update process may far less dynamic than the weight calculation process. As such the cell search update may be done every predetermined number of weight calculation periods.

At least some embodiments of the components, systems, methods, computing devices, and/or code instructions described herein address the technical problem of reducing or preventing interference for a drone (e.g., implementation of UE), for example, from neighboring base stations and/or other interferers and/or jammers. At least some embodiments of the components, systems, methods, computing devices, and/or code instructions described herein improve the technology of drone communication, by providing approaches for reducing and/or preventing interference for the drone. Drones may be equipped with cellular communication capabilities to enable them to establish a connection with cellular networks, such as LTE or 5G, and/or to facilitate communication with the ground control station and/or remote pilot. The cellular communication for the drone provides several benefits and functionalities for drones, for example: Remote Control and Telemetry, Beyond Visual Line of Sight (BVLOS) Operation, Real-time Video Streaming, and Mission Planning and Updates.

When a drone is connected to an LTE or 5G network, it communicates with multiple base stations, also known as eNodeBs (for LTE) or gNodeBs (for 5G). These base stations serve as access points to the cellular network and facilitate the drone's communication with the ground control station or remote pilot.

In some scenarios, a drone flying in an urban or densely populated area may encounter multiple eNodeBs within its range. This can lead to elevated interference due to several reasons, for example:
1. Co-Channel Interference: In both 4G and 5G cellular networks, different base stations operate in the same co channel frequency channels which is named ‘frequency reuse one’ method. However, when a drone is in the vicinity of multiple eNodeBs, it may receive signals from adjacent channels, resulting in co-channel interference. This interference can degrade the quality of the received signal, lower the significantly the data throughput and affect the drone's communication performance in the downlink direction (base station to UE).
2. Interference from Multiple Transmitters: Multiple eNodeBs in proximity mean there are multiple transmitters operating simultaneously. These transmitters can generate electromagnetic radiation that interfere with each other, leading to signal degradation or interference. The overlapping signals from nearby eNodeBs can introduce noise or distort the received signal, affecting the drone's ability to maintain a stable connection.
3. Handover, also known as handoff, is a crucial process in cellular networks where a mobile device, such as a drone, seamlessly transfers its connection from one base station to another as it moves within the network coverage area. While handover is designed to ensure continuous and uninterrupted communication, there can be some challenges associated with it in both 4G and 5G networks.

Problems with handover may impact drones as well as other mobile devices that change location, and/or other implementations of the UE, which may trigger the handover. Some common problems with handover include:
Ping-Pong Handover: Ping-pong handover occurs when a mobile device and/or drone repeatedly switches between two neighbouring base stations. This can happen, for example, due to signal fluctuations and/or overlapping coverage areas. Ping-pong handover may lead to unnecessary handover attempts, increased signalling load on the network, and/or potential disruption in the communication link.
Delay and Packet Loss: During a handover, there is a brief interruption in the connection as the mobile device and/or drone transitions from one base station to another. This interruption may result in delay and packet loss, affecting real-time applications and/or services like video streaming or remote control of the drone. Minimizing the handover duration and optimizing handover algorithms is crucial to mitigate these issues.
Interference and Signal Strength: Handover decisions are typically based on signal strength measurements. However, in some cases, neighbouring base stations may have similar signal strengths, leading to difficulties in making accurate handover decisions. This may result in suboptimal handovers and/or handover failures, impacting the quality of the connection and introducing interference.

To address the above mentioned strong self-interference that degrades significantly the DL throughput and the handover challenges for the UE (e.g., mobile device, drone), network operators and equipment manufacturers employ various techniques and optimizations. These include, for example, advanced handover algorithms, better interference management, adaptive antenna systems, and improved signalling protocols. Additionally, ongoing standardization efforts and advancements in 5G network architecture aim to enhance handover capabilities and minimize the associated issues for a seamless user experience.

To mitigate interference caused by multiple base stations (e.g., eNodeBs), network operators typically employ techniques such as frequency planning, power control, and interference cancellation algorithms. These measures aim to optimize the distribution of base stations, allocate appropriate frequencies, and minimize the impact of interference.

Advancements in technology, such as beamforming in 5G networks, can help improve signal quality and reduce interference effects. Additionally, drone manufacturers may implement advanced receiver designs and signal processing algorithms to mitigate interference and enhance the drone's overall performance in challenging environments.

At least some embodiments of the components, systems, methods, computing devices, and/or code instructions described herein address the aforementioned technical problem(s), and/or improve the aforementioned technical field(s), and/or improve upon the aforementioned prior approaches, by enabling cancellation of interference signals for UE, optionally UEs that change location, for example, drones and/or mobile devices.

At least some embodiments of the components, systems, methods, computing devices, and/or code instructions described herein grant jamming immunity to the UE.

At least some embodiments of the components, systems, methods, computing devices, and/or code instructions described calculate weights for cancelling reception of existing jammers, for example, using the Wiener approach.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

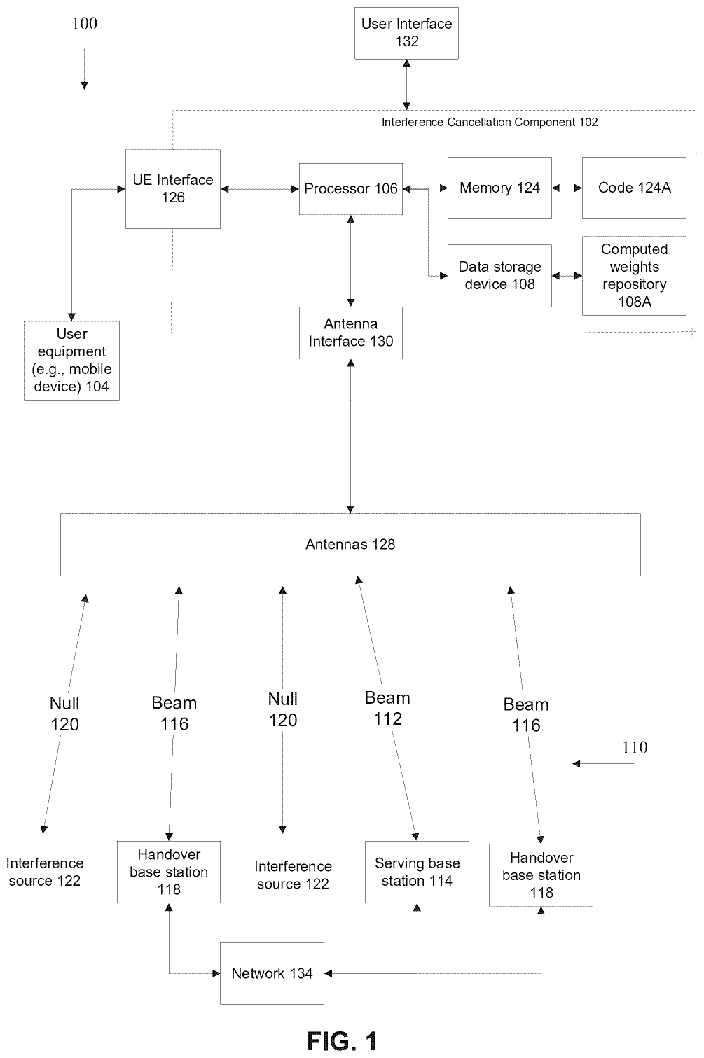

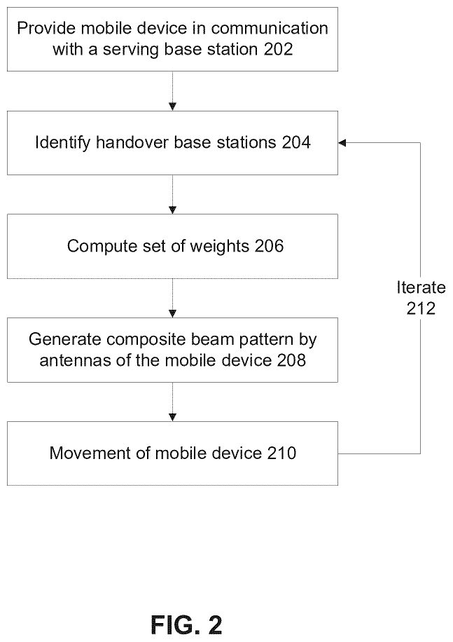

Reference is now made to FIG. 1, which is a block diagram of a system 100 that includes an interference cancellation component 102 for mitigating foreign interference for a user equipment 104, in accordance with some embodiments of the present invention. Reference is also made to FIG. 2, which is a flowchart of a method for mitigating foreign interference for a user equipment, in accordance with some embodiments of the present invention.

System 100 may implement the acts of the method described with reference to FIG. 2, optionally by interference cancellation component, for example, by a processor(s) 106 therefore executing code instructions 124A stored in a memory 124.

Referring now back to FIG. 1, interference cancellation component 102 mitigates foreign interference for user equipment 104. Interference cancellation component (e.g., processor 106 thereof) computes a set of weights (e.g., stored in a computed weights repository 108A) for generating a composite beam pattern 110 that includes beams 112 steered towards a serving base station 114, and may include beams 116 steered towards one or more of one or more handover base stations 118, and that forms null 120 towards one or more interference sources 122.

Interference cancellation component 102 may be implemented as, for example, a component integrated within user equipment 104, a component that connects to user equipment 104 optionally via a UE interface 126, and the like. Interference cancellation component 102 may be implanted as a stand-alone component, that plugs in between an interface of antennas 128 associated with user equipment (e.g., via an antenna interface 130) and an interface of UE 104 (e.g., via UE interface 126). Interface cancellation component 102 may be implemented as an add-on to the user equipment (e.g., mobile device) 104.

Interface cancellation component 102 includes a processor 106, for example, a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include one or more processors (homogenous or heterogeneous), which may be arranged for parallel processing, as clusters and/or as one or more multi core processing units.

Interface cancellation component 102 includes memory 124 that stores code instruction 124A for execution by processor(s) 106, for example, a random access memory (RAM), read-only memory (ROM), and/or a storage device, for example, non-volatile memory, magnetic media, semiconductor memory devices, hard drive, removable storage, and optical media (e.g., DVD, CD-ROM). For example, memory 124 may code 124A that implement one or more acts and/or features of the method described with reference to FIG. 2, as described herein.

Interface cancellation component 102 may include a data storage device 108 for storing data, for example, computed weights repository 108A that stores the computed weights described herein. Data storage device 108 may be implemented as, for example, a memory, a local hard-drive, a removable storage device, an optical disk, a storage device, and/or as a remote server and/or computing cloud.

Interface cancellation component 102 may include antenna interface 130 for interfacing with antennas 128, such as for electrically coupling to antennas 128. Antenna interface 130 may be bi-directional, for example, for generating instructions for forming the beam described herein (with steered beams 112 and 116, and formed null 120) using the computed weights (e.g., stored in computed weights repository 108A), and/or for receiving signals from antennas 128 transmitted by serving base station 114, and/or for sending signals to serving base station 114 via antennas 128.

Antennas 128 may be located, for example, integrated and/or installed within interference cancellation component 102, integrated and/or installed within UE 104, and/or an external component external to UE 104 and/or external to interference cancellation component 102.

Interface cancellation component 102 may include UE interface 126 for interfacing (e.g., electrically coupling) with UE 104, for example, for sending signals obtained by antennas 128 from serving base station 114 via beam 112 (created using the computed weights (e.g., stored in repository 108A)) to UE 104, and/or for obtaining data from UE 104 to send to serving base station 114 via beam 112.

Interface cancellation component 102 may include one or more user interfaces 132 that includes a mechanism designed for a user to enter data and/or view data. Exemplary user interfaces 132 include, for example, one or more of, a touchscreen, a display, a keyboard, a mouse, and voice activated software using speakers and microphone. Optionally, user interface 132 is implemented as the user interface of UE 104, for example, a display of the mobile device.

It is noted that any one of handover base stations 118 may be designated as serving base station 114 after a hand-over. Two handover base stations 118 and/or two interference sources 122 are shown as a simple example, for clarity of explanation. It is to be understood that there may be a larger and/or different number of base stations and/or interference sources.

Service base station 114 and handover base station 118 may be connected to a same network 134, for example, a cellular network, such as according to 5G standards, and/or LTE.

Service base station 114 and handover base station 118 may be implemented as, for example, eNodeBs (for LTE) and/or gNodeBs (for 5G).

Referring now back to FIG. 2, at 202, a mobile device is provided. The mobile device is in communication with a serving base station, for example, of a wireless (e.g., cellular) network.

The antennas of the mobile device that communicate with the serving base station may receive undesired signals from one or more interference sources. For example, the interference source(s) may include another interfering base station in communication with the wireless network that includes the serving base station and handover base station(s) to which the mobile device may potentially handover to. The other interfering base station may generate frequency reuse noise by reusing a frequency band used by the serving base station and/or one or more of the handover base stations. Such situation may occur, for example, when the mobile device is implemented as a drone. The flying drone may be more prone to frequency reuse noise from interference source implemented as other handover base stations, for example, since the line of site to the interference source may not be blocked by objects such as buildings, such as in contrast to phones of users walking around whose line of site may be blocked by the objects.

A set of weights, as described herein, may be selected (e.g., computed) for nulling the interfering base station's frequency reuse noise.

At 204, one or more handover base stations that the mobile device is likely to handover to are identified. The handover base stations may be included in a list and/or database.

When there are multiple base stations in proximity, the identified handover base stations represent a subset of candidate base stations from the available multiple base stations, to which the mobile device is likely to be handed over to. The handover may occur, for example, due to movement of the mobile device to a new location, and/or other factors such as drop in signal strength of the communication link with the serving base station.

Optionally, a serving base station that is serving the mobile device is identified. The serving base station may be currently serving the mobile device. Alternatively, the serving base station may represent the best handover base station to which the mobile device is to be handed to, and/or to which the mobile device should connect to. For example, the communication signals from the serving base station are stronger than from other base stations.

A brief summary of an approach for identifying the handover base stations and/or the serving base station is now described. The handover base stations and/or the serving base station may be identified by searching for unique signals generated by each of the available base stations. Receptive power levels of the unique signals may be sorted in descending order. A predefined number of highest power unique signals may be selected, and/or unique signals have a power above a threshold may be selected. The serving base station may be selected according to a highest power unique signals. The handover base stations may be selected according to descending power of the unique signals, optionally while remaining above the threshold.

Additional details of the aforementioned brief summary of the approach are now described.

The unique signals generated by the available base stations may be known in advance. The unique signals may be a desired response signature. The signature should be any known transmitted signal of multiple base stations (e.g., EnodeB), including the serving base station and one or more neighboring base stations that the mobile device may potentially handover to. In order to predict pertinent base station signatures, i.e., the unique signature(s), the Physical Cell Id (PCI) of each relevant base station (e.g., EnodeB) may be obtained ahead of time. The PCI values may be retrieved, for example, from the UE database (e.g., that includes the serving base station and/or neighboring base station(s) which may include the handover vase station(s)). In another example, the PCI value may be retrieved by emulating part of the regular cell search process that the UE receiver usually performs. The cell search may be is done by monitoring base station (e.g., EnodeB) download (DL) periodic synchronization signal, such as the primary and/or secondary (PSS and/or SSS) synchronization signals. The reception power level of PSS and/or SSS may be sorted, optionally in descending order. The first predefine number and/or above a power threshold may be selected as the set of the serving base stations and handover base stations (e.g., neighboring for handover) that are be regarded as the desired signal for the calculated cancellation weights (e.g., based on the Wieners solution approach).

The unique signature of each base station (e.g., in a list and/or the database) may be found, for example, using an expected Cell specific Reference Symbols (CRS). The CRS may be the DL pilots for enabling the mobile device (e.g., UE receiver) to perform its regular DL channel estimation.

Optionally, the interference sources (e.g., from a jammer) are strong enough for preventing or making it difficult to obtain the unique signature. For example, disabling the PSS and/or SSS detection during the cell search stage. An additional pre-processing phase may be implemented. The presence of an interference signal originating from foreign transmitting source(s) in the received signals received by the antennas of the mobile device may be detected. The presence of the unique signals in the received signals may be determined. Cancellation weight for a suitable combination of the received signals may be computed, such that the cancellation weights calculated based on existence of the interference signal and unique signals reject the interference signal, and leave the unique signals substantially unaffected. For example, a Minimum Noise Wiener solution weight may be calculated in order to mitigate the jammer. In case of strong jammers significantly above all base station reception, the Minimum Noise Wieners Solution weights may cancel the strong jammer very effectively. It is noted that there is known rule used when applying the Wiener solution that is referred to as a ‘Power Inversion Phenomena’. This rule stipulates that if a jammer's power level is a certain amount (e.g., in decibels (dB)) above the desired signal level after applying the Wieners solution, even if the number of antennas does not meet the required degrees of freedom rule, the level of the jammer in the clean output after the weighting process (i.e., the jammer free output branch) is predicted to be the same (or similar within a range) amount (e.g., in dB) below the desired signal power at the clean branch output. Out of the resulted clean output branch, the original received DL signal is expected to be visible. The PSS+SSS signal is expected to be retrieved without additional difficulties.

At 206, a set of weights for generating a composite beam pattern by the antennas associated with the mobile device, is computed. The composite beam pattern includes beams steered towards the serving base station and at least one of the identified handover base station(s), and the composite beam pattern forms null towards at least one interference sources. In other words, for each handover base station (e.g., EnodeB) in the list, a respective set of weights may be computed for steering a maximum beam to each pertinent base station that includes the serving base station and the identified handover base stations (e.g., beam former) and null (e.g., null former) toward each jammer (i.e. interference source) and all other base stations. The null remove or reduce the interference signals received by the antennas from the serving base station and/or handover base station(s).

The set of weights are computed for reducing and/or eliminating interference by the interference sources on a download link (DL) of the mobile device from the serving base station and/or from the handover base station(s).

The set of weights may be computed according to signal trace of the interference sources and/or of the serving base station and/or the handover base station(s). A time interval of the signal trace is significantly longer than reception slot duration of the mobile device.

Optionally, a sub-set of weights is computed for each handover base station and for the serving base station. Each sub-set of weights is for steering a respective beam generated by the antennas of the mobile device to the respective handover base station (i.e., the serving base station and/or handover base station). Each sub-set of weights is also computed for forming a null towards the other handover base stations, that are different from the respective handover base station, i.e., excluding the respective handover station and towards each interference source. The set of weights may be computed as a combination of the multiple sub-sets of weights.

One or more of the following may be performed for calculating a respective set of weights for each base station: Finding DL reception timing for each base station reception from the list. Generating the expected DL CRS symbols for each base station from the list. Calculating cancelation weights for each base station from the list as desired signal(s). In the data path there may be a predefined number of parallel multiple +add weighting circuits that each generate one clean signal (jammer free) branch. As such, that for each base station of the predefined number (e.g., in the list) there may be the predefined number of clean branches. These predefined number of clean branches may be delivered to the base station with one or more of the following case options: Will be delivered each to the UE receiver branch and let the UE processor (e.g., DSP) to handle the optimal combination, for example, using its existing maximum-ratio combining (MRC) diversity process. To add all the predefined number of clean branches to one branch and to deliver them to one of UE receiver branches. To deliver to the UE receiver branches, each sum of different subgroup of the clean branches out of the available predefined number of clean branches. The MRC diversity process may be used to find the optimal combination.

At 208, the antennas associated with the mobile device generate a composite beam (e.g., radiation) pattern that includes beams (e.g., beam peaks) steered towards the serving base station and one or more of the handover base stations. The beam(s) steered towards the handover base stations may be used for enabling handover from the serving base station to one of the handover base stations. The composite beam further forms null towards one or more interference sources. The composite beam is generated using the weights computed as described with reference to 206.

The beam(s) (e.g., beam peaks) and formed null enable operation of the approach described herein even when there are no interference sources (e.g., jammers) in existence. In such a case, frequency reuse noise may be removed from other base stations of the network.

It is noted that the rule of thumb for a complete degree of freedom solution handling for maximum SINR category may be that the number of reception antennas should be greater than the number of interference sources (e.g., jammers) plus the number of handover base stations (e.g., in the list and/or database). It is noted that the rule of thumb may represent a general guideline that is not necessarily met in all cases.

Optionally, the number of antennas in communication with the mobile device (e.g., installed thereon) may be selected for providing sufficient degrees of freedom for maximum SINR. Optionally, the number of antennas is selected to be greater than a number of interference sources (e.g., predicted number) and a number of handover base stations (e.g., predefined number of handover base stations which are selected).

Alternatively or additionally, the number of antennas may be reduced while still providing an acceptable protection for the mobile device against interference (e.g., maintaining a measure of interference above a threshold). The number of antennas may be reduced below a sum of a number of interference sources and the number of base stations (which includes the serving base station and the handover station(s)), while maintaining sufficient degrees of freedom for cancellation of the interference sources.

Some exemplary approaches (which may be combined) are now described:
The antennas of the mobile device may be implemented as an antenna array (e.g., linear spatial antenna array), optionally excluding a polarization array. The handover base stations, optionally clusters of EnodeB sectors, each with several Tx MIMO branches, may share a common spatial null (e.g., formed null) and/or a common beam (e.g., peak angle of arrival). The same null and/or peak may be steered towards the group of handover base stations, for example, to all transmitting antenna from the common cell site—all its sectors and MIMO branches. In response to the antennas associated with the mobile device being implemented as an antenna array (that may exclude a polarization array), a common beam is steered towards two or more of the serving base station and/or handovers base stations. Alternatively or additionally, in response to the antennas associated with the mobile device implemented as an antenna array, a common null is formed towards two or more of the interference sources.
The antennas of the mobile device may be implemented as one or more of: a vertical array, a horizontal antenna array, and/or a polar array. A common null may be formed and/or a common beam may be steered towards a group of the handover base stations. With vertical array there may be higher likelihood that several handover base stations (e.g., EnodeBs) at sufficient distance will exhibit angle of arrival of common vertical null and/or beam peak. The interference source (e.g., jammer) may have partially common null. Any commonality either in the null or in the beam peak may lower the required degrees of freedom number. In response to the antennas associated with the mobile device implemented as a vertical array, a common null may be formed and/or a common beam may be steered towards the group of handover base stations.
In response to the handover base stations having known bounded angle of arrival spread, the antennas associated with the mobile device may be implemented as directional antennas designed to cover the known bounded angle of arrival spread. This may lower the required number of degrees of freedom significantly, leading to fewer required antennas for the mobile device.
In response to inability to form null towards the interference sources, the cancellation weights may be selected for generating a single beam with narrow width directed towards the serving base station, i.e., towards a single base station. The beam is not directed towards the handover base stations. For example, since the cancellation weight computational approaches (e.g., Maximum SINR Wiener solution) employ the beam former to a single base station (e.g., EnodeB), the beam former does not (e.g., never) suffers from lack of degrees of freedom. As such with sufficiently large linear antenna array associated with the mobile device, the beam width should be significantly narrow—for providing sufficient SINR improvement, such as if it is difficult or impossible to steer null(s) toward the current unwanted transmitters (e.g., of them) such as the interference sources.
In response to reception power from remote interference sources being significantly lower than reception power from closer interference sources, the set of weights may be computed for forming null towards the closer interference sources and ignoring the remote interferences sources. The reception power from a remote interference source such as a base station (e.g., EnodeB) may be very low compared to nearer interference sources. The signals received from the remote interference sources may be weak enough when received by the antennas of the mobile device, such that they can be ignored (e.g., assumed to not impact the desired signals) in computation of the cancellation weights. Any significant variance in the reception power level of the unwanted transmitters, i.e., interference sources, may play in favor of the limited number of the degrees of freedom challenge. The power inversion rule may place null toward the dominant interference source. The number of interference sources that are close may be for meeting the degrees of freedom rule.

At 210, the mobile device may move to a different location. As a result of the move, the antennas of the mobile device may receive a different combination of the signals from the serving base station, the handover base stations, and/or the interference source(s), such as different strengths and/or signals from different base stations and/or different sources. The previously computed cancellation weights may be unsuitable for the new location, i.e., may not reduce or cancel the interference sources at the new location.

For example, the mobile device may be implemented as, and/or installed within a drone. The drone changes locations during flights.

At 212, one or more features described with reference to 204-210 may be iterated over time, for example, at predefined time intervals, and/or in response to events such as changing location of the mobile device.

Optionally, a new set of handover base stations (e.g., using the cell search approach described herein) may be identified from a candidate base stations, as described with reference to 204. A new set of the weights for steering the beam to another handover base station may be computed, as described with reference to 206.

Optionally, the identification of the handover base stations (e.g., using the cell search process described herein) as described with reference to 204, may be performed in a periodic fashion, optionally in parallel to the process of calculating weights, as described with reference to 206, for updating the identified handover base stations (e.g., the list and/or database). For example, the process of identification of the handover base stations may be performed at predefined time intervals, and/or triggered by events such as movement of the mobile device. The calculation of weights may be performed, for example, continuously (e.g., iteratively without significant delay between iterations), at predefined time intervals, and/or triggered by events.

Since the weight calculation process employs both beam former and null steering, the period of weight calculation may be sufficiently short in order to accommodate the null steering dynamics. A time interval for computing the new set of the set of weights for forming the null (e.g., as described with reference to 206) may be selected to be shorter than a time interval in which the null significantly changes location in response to changing location of the mobile device (e.g., as described with reference to 210).

The time interval for computing the weights may be set and/or dynamically adapted according to movement of the mobile device, for example, according to speed of movement of the mobile device. For example, the time interval is shortened when the mobile device moves faster and/or the time interval is increased when the mobile device moves slower.

Optionally, a time interval for identifying the new set of handover base stations as described with reference to 204, may be significantly longer than the time interval for computing the new set weights as described with reference to 206 and/or for forming the beam as described with reference to 208. The time interval for identifying the new set of handover base stations may be longer since upon movement of the mobile device, the signals received from the same base stations may change while the base stations remain the same set (to which it is possible to hand over to). As such, a faster change in weights may be used to adapt to the changing received signals to remove or reduce interference, for the same set of base stations.

The weight computation (e.g., as described with reference to 206) and/or beam formation phases (e.g., as described with reference to 208) may be updated with significantly longer period than for identifying the handover bases since they may exhibit far lower dynamics, for example, reduced impact due to motion of the mobile device. As such, the computationally heavy processes of finding base station (e.g., EnodeB) timing and/or generating their current expected CRS may be done periodically and/or at significantly lower rate than of computing the weights and/or forming the beam. The list of identified handover bases may be updated, for example, every predefined time period of the null steering and/or beam formation and/or weight cancellation.

Also, the cell search update process is far less dynamic than the weight calculation process. As such it can be done every TBD weight calculation period.

For an example of the drone as the UE and/or the mobile device, protecting the drone against interference may be an important and/or crucial tool for drones that employ cellular communication. The drone performs an update (e.g., continuously, periodically) of the list of handover base stations (e.g., eNodeBs or gnodeBs) by searching (e.g., continuously, periodically) for unique signals such as eNodeBs/gNodeB unique preambles, and measuring their received power strength (e.g., PSS+SSS). A dynamic list of base stations (e.g., EnodeBs) with the strongest received power may be maintained, for example in the UE interference cancelation system memory. The list may be referred to as the handover base stations and/or as the neighboring base station (e.g., EnodeBs) list. Beams are steered towards the hand over base stations (e.g., all of them) that are currently members in the aforementioned neighboring EnodeBs list with its digital beam former capabilities while concurrently null may be steered toward the base stations (e.g., EnodeBs), optionally all base stations, that are not members in the list but are still received with sufficient power to interfere with the desired signal, in order to mitigate their potential interference with the digital null steering capabilities

In order to enable adaptive multiple beam and/or multiple null steering it may be necessary to facilitate the system described herein with sufficient degrees of freedom, namely number of receiving antennas. As a rule of thumb, in order to provide an accepted level of performance, the number of receiving antenna may be more than the number of the handover base stations (e.g., neighboring eNodeBs) and where their received power crosses a predetermined threshold that is potentially causing interfering damage.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant antennas and base stations will be developed and the scope of the terms antenna and base stations are is intended to include all such new technologies a priori.

As used herein the term “about”refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound”may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. An apparatus for improving signal to interference and noise ratio (SINR) of a communication device connected to a cellular network, comprising:
a processor executing a code for:
identifying a serving base station that is serving the communication device;
identifying at least one handover base station that the communication device is likely to handover to; and
computing a set of weights for generating by a plurality of antennas associated with the communication device, a composite beam pattern that includes beams steered towards the serving base station and for the at least one handover base station, wherein the set of weights are computed according to signal trace of the serving base station and the at least one handover base station.

2. The apparatus of claim 23, wherein the set of weights are computed for reducing or eliminating interference by the interference sources on a download link (DL) of the communication device from the serving base station.

3. The apparatus of claim 1, wherein a time interval of the signal trace is significantly longer than reception slot duration of the communication device.

4. The apparatus of claim 23, wherein the processor further executes code for:
for a respective handover base station of the handover base stations, computing a sub-set of weights for steering a beam generated by the plurality of antennas to the respective handover base station and forming a null towards at least one of the handover base stations excluding the respective handover station and towards at least one of the interference sources; and
computing the set of weights as a combination of a plurality of the sub-set of weights.

5. The apparatus of claim 23, wherein the interference source comprises at least one other interfering base station in communication with a wireless network that includes the serving base station and at least one handover base station, the at least one other interfering base station generating frequency reuse noise by reusing a frequency band used by at least one of the serving base station and the at least one handover base station, wherein the set of weights are selected for nulling the interference base station's frequency reuse noise.

6. The apparatus of claim 1, wherein the processor is configured for performing in a plurality of iterations:
identifying a new set of the at least one handover base station from a plurality of candidate base stations, and
computing a new set of the set of weights for steering the beam to another handover base station.

7. The apparatus of claim 6, wherein a time interval for computing the new set of the set of weights for forming the null is selected to be shorter than a time interval in which the null significantly changes location in response to changing location of the communication device.

8. (canceled)

9. The apparatus of claim 6, wherein the communication device is installed within a drone, and the processor executes the plurality of iterations as the drone changes locations.

10. The apparatus of claim 6, wherein the processor executes the plurality of iterations in response to changing locations of the communication device.

11. The apparatus of claim 1, wherein the at least one handover base station and the serving base station are identified by:
searching for unique signals generated by each of a plurality of base stations;
sorting receptive power levels of the unique signals in descending order; and
selecting a predefined number of highest power unique signals,
wherein the serving base station is selected according to SINR unique signals and the at least one handover base station is selected according to descending SINR of the unique signals.

12. The apparatus of claim 11, wherein the processor is further configured for:
determining the presence of an interference signal originating from at least one foreign transmitting source in received signals received by the plurality of antennas;
determining the presence of the unique signals in the received signals;
calculating cancellation weight for a suitable combination of the received signals, such that the cancellation weights calculated based on existence of the interference signal and unique signals reject the interference signal, and leave the unique signals substantially unaffected.

13. The apparatus of claim 1, wherein the apparatus is implemented as an add-on to the communication device, and further comprising a first interface for electrically coupling to the plurality of antennas, and a second interface for electrically coupling to the communication device.

14. The apparatus of claim 23, wherein a number of the plurality of antennas associated with the communication device is below a sum of a number of interference sources and a number of the serving base station and the at least one handover station, exploiting available degrees of freedom for cancellation of the interference sources.

15. The apparatus of claim 14, wherein at least one member selected from the group consisting of:
(a) in response to the plurality of antennas associated with the communication device implemented as an antenna array, a common beam is steered towards two or more of the serving base station and/or handovers base stations.

16-17. (canceled)

18. The apparatus of claim 1, wherein in response to the at least one handover base station having known bounded angle of arrival spread, the plurality of antennas associated with the communication device are implemented as directional antennas configured to cover the known bounded angle of arrival spread.

19. The apparatus of claim 23, wherein in response to inability to form nulls towards the interference sources, the set of weights are selected for generating a single beam with narrow width directed towards the serving base station.

20. The apparatus of claim 23, in response to reception power from remote interference sources being significantly lower than reception power from closer interference sources, computing the set of weights for forming nulls towards the closer interference sources and ignoring the remote interference sources.

21. A method of improving signal to interference and noise ratio (SINR) of a communication device connected to a cellular network, comprising:
identifying a serving base station that is serving the communication device;
identifying at least one handover base station that the communication device is likely to handover to; and
computing a set of weights for generating by a plurality of antennas associated with the communication device, a composite beam pattern that includes beams steered towards the serving base station and for the at least one handover base station, wherein the set of weights are computed according to signal trace of the serving base station and the at least one handover base station.

22. A non-transitory medium storing program instructions for improving signal to interference and noise ratio (SINR) of a communication device connected to a cellular network, which when executed by at least one processor, cause the at least one processor to:
identify a serving base station that is serving the communication device;
identify at least one handover base station that the communication device is likely to handover to; and
compute a set of weights for generating by a plurality of antennas associated with the communication device, a composite beam pattern that includes beams steered towards the serving base station and for the at least one handover base station, wherein the set of weights are computed according to signal trace the serving base station and the at least one handover base station.

23. The apparatus of claim 1, wherein said composite beam pattern further forms null towards at least one interference source, wherein the set of weights are computed according to signal trace of the interference sources and of the serving base station and the at least one handover base station.
